(19) United States
(12) Patent Application Publication
(10) Pub. No.: US 2003/0035015 A1
(43) Pub. Date: Feb. 20, 2003

(54) Printhead pressure relief mechanism

(76) Inventors: Kevin Girard Conwell, Fairfield, IL (US); Matt Adams, Cincinnati, OH (US)

Correspondence Address: ORUM & ROTH, 53 W. JACKSON BLVD, CHICAGO, IL, 60604, US

(21) Appl. No.: 10/121,093

(22) Filed: Apr. 11, 2002

Related U.S. Application Data
(60) Provisional application No. 60/283,111, filed on Apr. 11, 2001.

(51) Int. Cl. B41J 25/308

(52) U.S. Cl. 347/8

(57) ABSTRACT

A printhead pressure relief mechanism using a non-mechanical media thickness monitoring apparatus. An increase in media thickness is monitored by an emitter/detector pair, a piezo-electric pressure sensor mounted on the print head, a metal detector or a RFID read/write assembly.

This application claims the benefit of U.S. Provisional Application Ser. No. 60/283,111 filed Apr. 11, 2001.

### BACKGROUND OF THE INVENTION

1. Field of the Invention

The present invention is directed to printheads, specifically to a printhead having a pressure relief mechanism initiated by the approach of an RFID circuit located on or within the print media.

2. Description of the Related Art

JP 11138941 describes a thermal printer system in which a mechanical sensor is used to detect the presence of a high spot in print media. When the mechanical sensor detects a high spot a head lifting mechanism is activated which moves the printhead to a non-contact position, off of the surface of the print media.

This design is susceptible to premature wear and failure due to repeated mechanical cycling of the sensor between up and down positions and use of a roller and spring. The roller and spring mechanism being susceptible to fowling from stray fibers and other contaminants associated with print media. When a high point is detected, the printhead is completely removed from contact with the print media, removing the ability for printing upon the raised section of print media. The mechanical head lifting mechanism is not adjustable to compensate for use of thicker or thinner overall print media. If too thick a print media is used, it is possible that the sensor will be permanently raised, preventing operation of the printer.

RFID tags typically range between 10-20 mils in thickness. Conventional thermo-printers are capable of printing upon print media with a thickness in the range of 3-12 mils. As an RFID circuit embedded in print media passes a printhead the printhead pressure at the contact point can theoretically increase by as much as six times. Abnormal pressure at the printhead contact point causes premature wear due to increased abrasion and creates an increased opportunity for over heating of the print media against the printhead heater elements. If an even pressure is maintained between the printhead and print medium, continuous printing is enabled and printhead life is extended.

### DESCRIPTION OF THE FIGURES

FIG. 1 is a diagram of one embodiment of the invention.

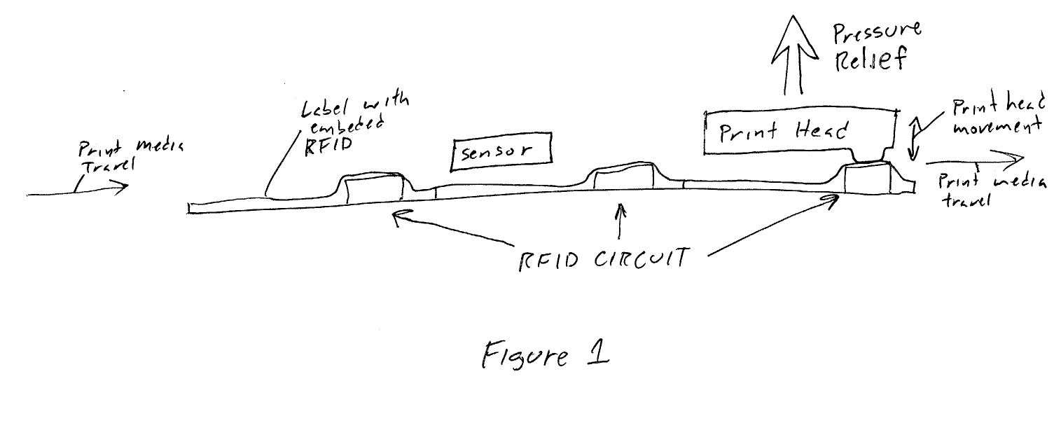

### DETAILED DESCRIPTION

The present invention replaces the previous electromechanical sensor with a solid state sensor. Rather than lifting the printhead, the present non-obvious invention releases the pressure upon the printhead. This enables the printhead to print along the edges of the passing RFID tag, for example along the top of the RFID tag and along the falling edge of the RIFD tag. Headwear is minimized by the release of pressure yet printing is not interrupted.

In a first embodiment, the sensor is an array of solid state photocells and LEDs paired to transmit and detect infrared or visible light through the label stock. The sensor(s) are positioned in the immediate path prior to the printhead, the full width of the printpath may be covered so that detection of an RFID tag will occur regardless of its location within the print media.

In a second embodiment, the sensor may be a piezo-electric pressure sensor. As an embedded transponder passes, the sensor will detect the pressure change caused by the RFID circuit and release the pressure holding the printhead in position. The pressure sensor may be located directly on the thermal printhead itself or in the immediate path below the printhead.

In a third embodiment, the read/write antenna used for interacting with the RFID integrated into the print medium may be used as a proximity sensor to detect the location and position of the embedded transponder prior to its arrival at the printhead position. A voltage level representing the signal received from the transponder will vary depending on the distance of the transponder to the antenna, this allows calculation of the antenna location with respect to the transponder.

A fourth embodiment uses a metallic proximity sensor to detect the transponder's antenna.

In all of the sensor embodiments once the location of the RFID tag is detected, the printhead pressure relief may be initiated and then re-engaged for continued printing of the print media after the RFID circuit has passed. Depending on the sensor used, a calculated time delay may be performed to determine the proper instant/period for actuating the pressure relief.

Depending on the type of print media and printhead used the pressure on the printhead may be reduced rather than fully released. A lessened pressure compensating for the increased thickness of print media over an RFID but still maintains enough pressure for clear printing.

The present invention extends the life of the printhead by preventing wear and or damage to the printhead. Also, as no mechanical linkage is included in the present inventions an additional failure point and or maintenance requirement for the printer is eliminated.

The present invention is also usable with print media other than RFID's. Any print media that includes non-planer surfaces, for example, machine and or candy in rolls of individual segmented pouch packaging, may utilize this invention.

We claim:

1. A printhead pressure relief mechanism comprising:
means for detecting an increase in thickness, and
a printhead pressure relief mechanism;
whereby upon detection of an increase in media thickness by the means for detecting, the printhead pressure relief mechanism is actuated.

2. The printhead pressure relief mechanism of claim 1 wherein, the means of detecting is an emitter and detector arranged so that an increase in the media thickness interrupts a line of sight between the emitter and the detector.

3. The printhead pressure relief mechanism of claim 1 wherein, the means of detecting is a piezo-electric presser sensor attached to the printhead, whereby an increase in pressure generated by a change in the media is sensed by the piezo-electric pressure sensor.

4. The printhead pressure relief mechanism of claim 1 wherein, the means of detecting is a metallic proximity sensor which detects a RFID antenna within the media.
